(19) United States
(12) Patent Application Publication
(10) Pub. No.: US 2023/0038338 A1
(43) Pub. Date: Feb. 9, 2023

(54) CONTROLLER AND OPERATION CONTROL METHOD FOR ELECTROLYSIS STACK MODULE POWERED BY RENEWABLE ENERGY POWER GENERATION DEVICE AND ELECTROLYSIS SYSTEM USING THE SAME

(71) Applicants: Hyundai Motor Company, Seoul (KR); Kia Corporation, Seoul (KR)

(72) Inventor: Se Yeong LEE, Suwon-si (KR)

(73) Assignees: Hyundai Motor Company, Seoul (KR); Kia Corporation, Seoul (KR)

(21) Appl. No.: 17/728,414

(22) Filed: Apr. 25, 2022

(30) Foreign Application Priority Data
Jul. 21, 2021 (KR) 10-2021-0096013

(51) Int. Cl. C25B 15/02; C25B 1/04; C25B 9/65

(52) U.S. Cl. CPC C25B 15/02; C25B 1/04; C25B 9/65

(57) ABSTRACT

A controller and an operation control method for electrolysis stack module powered by a renewable energy power generation device and an electrolysis system using the same, the controller being configured to control power supply by receiving the power supply from a renewable energy generator and distributing the power supply to n (n≥2) electrolysis stacks, wherein, the controller is configured to determine whether or not to drive each electrolysis stack according to stack driving conditions, no less than two, determined on the basis of a preset minimum amount of operating power supply for each electrolysis stack, and the stack driving conditions are ranges of an amount of the power supply in which on/off of the electrolysis stacks is predetermined, and the controller is configured to control driving of the electrolysis stacks according to the stack driving conditions corresponding to the amount of supplied power from the renewable energy generator.

### CROSS REFERENCE TO RELATED APPLICATION

The present application claims priority to Korean Patent Application No. 10-2021-0096013, filed Jul. 21, 2021, the entire contents of which is incorporated herein for all purposes by this reference.

### TECHNICAL FIELD

The present disclosure relates generally to an operation control technology for an electrolysis system powered by a renewable energy power generation device and, more particularly, to an operation control technology, for an electrolysis stack module, capable of improving hydrogen productivity of an electrolysis system associated with renewable energy with a large amount of variation in amount of power generation.

### BACKGROUND

Hydrogen has a very high energy density and, as being environmentally friendly energy, has the highest energy density per unit mass, thereby being in the spotlight as a next-generation energy source. There are various methods for producing hydrogen with high energy density, such as fossil fuel reforming, by-product gas generated from industrial processes, biomass gasification, electrolysis using renewable energy, and the like.

Among the hydrogen production methods, electrolysis is a method of obtaining hydrogen by separating water molecules into hydrogen and oxygen molecules using electricity. Electrolysis is an eco-friendly hydrogen production method, and the system is simple in configuration, stable in operation, and known as a technology capable of producing inexpensive hydrogen when low-cost power is connected.

Among electrolysis methods, alkaline electrolysis is a hydrogen production method known for a long time, may use 25-30 wt % of KOH (or NaOH) as an electrolyte, and includes a diaphragm for ion exchange and an electrode that generates hydrogen and oxygen.

In relation to such an electrolysis stack, oxygen and hydrogen are generated at an anode and a cathode, respectively, with a separation membrane as a reference during water electrolysis, and there is a possibility that a small amount of gas is mixed with each other.

In particular, in a low operating range, the amount of hydrogen and oxygen generated decreases, so the ratio of the hydrogen concentration to oxygen increases, thereby increasing risk of explosion.

Therefore, the general alkaline electrolysis stack has a limited operating range due to the risk of explosion.

The average operating range of the alkaline electrolysis stack is 15 to 100%, and in the operating range that is no greater than 15% of the stack capacity, the alkaline electrolysis stack may be limited not to be operated for safety reasons.

On the other hand, when renewable energy such as wind or solar power is used as a power source of the alkaline electrolysis stack, there is a problem in that hydrogen productivity is lowered due to high variability of the renewable energy.

The foregoing is only for improving the understanding of the background of the present disclosure and should not be regarded as acknowledging that the present disclosure corresponds to the related art that is already known to those of ordinary skill in the art.

### SUMMARY

Accordingly, the present disclosure is intended to provide a controller and an operation control method for an electrolysis stack module powered by a renewable energy power generation device and an electrolysis system using the same, in which hydrogen productivity is maximized while preventing risk of explosion when the electrolysis system is configured by linking the electrolysis stack module to renewable energy with high variability.

In particular, in consideration of the limitation of an operating range of the alkaline electrolysis stack module in the electrolysis system provided with a module including a plurality of alkaline electrolysis stacks, the present disclosure defines an efficient operation section of the module including a plurality of electrolysis stacks. In addition, electrolysis stack module operation control technology capable of carrying out hydrogen production even at a low load is to be provided by linking the operation section defined above to the amount of power supply of a renewable energy power generation device, which is another objective.

In order to achieve the above objective, there may be provided a controller for an electrolysis stack module powered by a renewable energy power generation device, the controller being configured to control power supply by receiving the power supply from a renewable energy generator and distributing the power supply to n (n≥2) electrolysis stacks, wherein, the controller may be configured to determine whether or not to drive each electrolysis stack according to stack driving conditions, no less than two, determined on the basis of a minimum amount of operating power supply preset in advance for each of the electrolysis stacks, and the stack driving conditions may be ranges of an amount of the power supply in which on/off of the electrolysis stacks is predetermined, and the controller may be configured to control driving of the electrolysis stacks according to the stack driving conditions to which an amount of power supply supplied from the renewable energy generator.

The stack driving conditions may consist of n numbers of conditions according to n numbers of ranges of the amount of the power supply, the controller may determine whether or not each of the electrolysis stacks is to be driven according to the n numbers of the stack driving conditions determined on the basis of the minimum amount of operating power supply preset in advance for each of the electrolysis stacks, and an electrolysis stack to be driven may be allocated for each of the stack driving conditions.

All of the n electrolysis stacks may have the same stack capacity A, and the minimum amount of operating power supply may be determined by a minimum operation coefficient α and the stack capacity A.

A lower limit value of each of the stack driving conditions may be set to a multiple of an integer, no greater than n, of the minimum amount of the operating power supply, and the range of the amount of power supply for each of the stack operating conditions may be determined as the magnitude of the minimum amount of operating power supply.

Among the stack driving conditions, a first stack driving condition in which a first electrolysis stack is operable with the minimum amount of the supplied power may be set to αA≤amount of supplied power<2αA, and the controller may control to drive only the first electrolysis stack under the first stack driving condition, and the electrolysis stacks allocated to the stack driving conditions, respectively, may be controlled to be sequentially driven in a driving start order according to an increase of the amount of supplied power.

In a state where a plurality of electrolysis stacks are being driven, when some of the electrolysis stacks need to be stopped due to a decrease in the amount of supplied power, the controller may control to stop driving the electrolysis stacks in reverse order of the driving start order.

After some of the electrolysis stacks are stopped due to a decrease in the amount of supplied power, when some of the electrolysis stacks need to be additionally driven as the amount of supplied power increases again, the controller may allow the electrolysis stacks allocated to each of the stack driving conditions to be driven.

In addition, according to the present disclosure, there may be provided an electrolysis system provided with the controller for the electrolytic stack module powered by a renewable energy generation device as described above and configured to control the electrolysis stack module through the controller. In addition, there may be provided an operation control method for an electrolysis stack module powered by a renewable energy power generation device, the operation control method may include controlling driving, by the controller, electrolysis stacks, the controlling driving may include receiving, by the controller, power from a renewable energy generator, distributing, by the controller, power supply to n (n≥2) electrolysis stacks, determining, by the controller, whether or not to drive each electrolysis stack according to stack driving conditions, no less than two, on the basis of a minimum amount of operating power supply preset in advance for each of the electrolysis stacks, and driving, by the controller, the electrolysis stacks according to the stack driving conditions to which an amount of power supply supplied from the renewable energy generator corresponds. The stack driving conditions may be ranges of an amount of the power supply in which on/off of the electrolysis stacks is predetermined.

The operation control method may further include, in a driving state of the electrolysis stack module: measuring the current power supply; checking whether the amount of the power supply is increased or decreased by comparing, by the controller, the previously measured amount of power supply W1 and the currently measured amount of power supply W2; and performing, by the controller, power supply control according to a result of the checking whether the amount of the power supply is increased or decreased, wherein the performing of the power supply control may include controlling, by the controller, the amount of the power supply supplied to electrolysis stacks allocated to the stack driving conditions according to the increased or decreased amount of the power supply.

The stack driving conditions may consist of n numbers of conditions according to n numbers of ranges of the amount of the power supply. The operation control method may further include determining, by the controller, whether or not each of the electrolysis stacks is to be driven according to the n numbers of the stack driving conditions determined on the basis of the minimum amount of operating power supply preset in advance for each of the electrolysis stacks, and an electrolysis stack to be driven may be allocated for each of the stack driving conditions.

All of the n electrolysis stacks may have the same stack capacity A, and the minimum amount of operating power supply may be determined by a minimum operation coefficient α and the stack capacity A.

A lower limit value of each of the stack driving conditions may be set to a multiple of an integer, no greater than n, of the minimum amount of the operating power supply, and the range of the amount of power supply for each of the stack operating conditions may be determined as the magnitude of the minimum amount of operating power supply.

Among the stack driving conditions, a first stack driving condition in which a first electrolysis stack is operable with the minimum amount of the supplied power may be set to αA≤amount of supplied power<2αA, and the controlling driving of the electrolysis stacks may further include driving, by the controller, only the first electrolysis stack under the first stack driving condition, and sequentially driving, by the controller, the electrolysis stacks allocated to the stack driving conditions, respectively, in a driving start order according to an increase of the amount of supplied power.

In a state where a plurality of electrolysis stacks are driven, when it is determined that some of the electrolysis stacks need to be stopped due to a decrease in the amount of supplied power, through the checking whether the amount of the power supply is increased or decreased, the performing of power supply control may further include controlling stopping driving, by the controller, the electrolysis stacks in reverse order of the driving start order.

When it is confirmed that, after the power supply control is performed as the amount of power supply decreases, after some of the electrolysis stacks are stopped to be driven due to the decrease in the amount of supplied power, the amount of the supplied power increases again through the checking whether the amount of power is increased or decreased, the operation control method may further include checking, by the controller, whether some of the electrolysis stacks need to be driven or not additionally as the amount of supplied power increases again, and allowing, by the controller, the electrolysis stacks allocated to the respective stack driving conditions to be driven when it is confirmed that some of the electrolysis stacks need to be driven additionally.

As described above, according to a controller and an operation control method for an electrolysis stack module powered by a renewable energy power generation device and an electrolysis system using the same of the present disclosure, stable hydrogen production is possible even in a condition where the amount of power supply generated from renewable energy is low, so the utility of renewable energy is improved and stable hydrogen production is secured.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a configuration diagram showing a schematic configuration of an electrolysis system including a controller for an electrolysis stack module powered by a renewable energy power generation device according to an embodiment of the present disclosure;

FIG. 2 is a flowchart illustrating an example in which supplied power increase/decrease control is performed according to the amount of power supply of a renewable energy generation device during operation of the electrolysis stack module;

FIG. 3 is a flowchart illustrating an example of performing control according to an increase in the amount of supplied power in an operation control method for an electrolysis stack module powered by the renewable energy power generation device according to the embodiment of the present disclosure;

FIG. 4 is a flowchart illustrating an example of performing control according to a decrease in the amount of supplied power in the operation control method for an electrolysis stack module powered by the renewable energy power generation device according to the embodiment of the present disclosure; and

FIG. 5 is a diagram illustrating an example related to an on/off control of an operation of the electrolysis stack according to an increase/decrease in the amount of supplied power in the operation control method for an electrolysis stack module powered by the renewable energy power generation device according to the embodiment of the present disclosure.

### DETAILED DESCRIPTION

A controller for an electrolysis stack module according to the present disclosure is usable to an electrolysis system connected to renewable energy. In addition, the present disclosure relates to the controller suitable for the electrolysis system including an electrolysis stack and an operation control method using the same, wherein the electrolysis stack is operated such that, like an alkaline electrolysis stack, in particular, an average operating range is limited to a predetermined range of, for example, about 5%˜100% of a stack capacity for safety reasons.

In this regard, the electrolysis stack in an exemplary embodiment of the present disclosure is a device configured to produce hydrogen and oxygen through electrolysis of water and is a device including an anode and a cathode, which are disposed to generate hydrogen and oxygen with a separation membrane as a reference. On the other hand, the electrolysis stack in the present disclosure is only used to refer to a device unit that is driven and controlled (control of the amount of supplied power including on/off of a stack) by a controller and is not meant attributively to a stack including a plurality of electrolysis cells. Therefore, when being a type that may be independently driven and controlled by the controller for the electrolysis stack, even a single electrolysis cell may be interpreted as being included in the electrolysis stack of the present disclosure. In addition, although the alkaline electrolysis stack is described as an example in the present specification, the present specification may be used for an electrolysis stack in a type that is incapable of being operated in a range no greater than a specific range of the stack capacity due to safety or other problems.

A renewable energy power generation device refers to a power generation device that produces energy using renewable energy such as wind power or solar power. In the case of a renewable energy generation device, the variability of the amount of supplied power is large depending on external factors such as weather. In other words, in the case of an electrolysis system linked to such a renewable energy generation device, that is, a system using the renewable energy generation device as an energy source, variability in the amount of supplied power is fundamentally inevitable. Thus, in consideration of such variability in the amount of power generated, there is a technical gist in the present disclosure to provide a system in which stable hydrogen production may be carried out even under conditions where the amount of supplied power is low. Therefore, an electrolysis system linked to a renewable energy power generation device is described in exemplary embodiments as an example in the present disclosure, but it should be noted that the present disclosure is not limited to such an example and, in particular, does not limit the applicability of the electrolysis system linked to an energy source having variability in the amount of power production.

Hereinbelow, the controller and operation control method for an electrolysis stack module powered by a renewable energy power generation device and an electrolysis system using the same according to embodiments in various forms of the present disclosure will be described in detail with reference to the accompanying drawings.

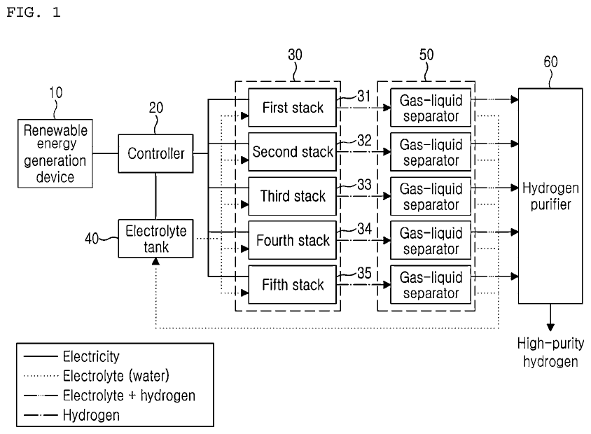

FIG. 1 is a configuration diagram explaining a controller for an electrolysis stack module powered by the renewable energy power generation device according to an embodiment of the present disclosure and showing a schematic configuration of an electrolysis system in which the electrolysis stack module is operated and controlled by a controller according to the present disclosure.

Lines displayed differently from each other in FIG. 1 represent movement paths of electricity, electrolyte (water), electrolyte+hydrogen, and hydrogen, respectively.

As shown in FIG. 1, the electrolysis system including a controller 20 according to the present disclosure is connected to a renewable energy generation device 10 and configured to receive power produced from the renewable energy generation device 10 and drive an electrolysis stack module 30. The controller 20 is configured to convert the power supply supplied from the renewable energy generation device 10 and to distribute the power supply to each of electrolysis stacks 31, 32, 33, 34, and 35. To this end, the controller 20 may include a power conversion device configured to receive the power supply generated from the renewable energy generation device 10 and convert the power supply into power supply suitable for driving the electrolysis stacks 31, 32, 33, 34, and 35. The controller 20 may include at least one memory to store instructions or algorithms for the disclosed functions of the controller, and at least one processor executing the stored instructions or algorithms to perform the disclosed functions.

An electrolyte such as 25-30 wt % of KOH is stored in the electrolyte tank 40, and the electrolyte stored in the electrolyte tank 40 may be supplied to an electrolysis stack module 30 by a pump.

The electrolysis stack module 30 includes a plurality of electrolysis stacks 31, 32, 33, 34, and 35, the electrolysis stacks being no less than two, and is configured to receive the electrolyte from the electrolyte tank 40 and to produce hydrogen through electrolysis performed by using the power supply supplied from the renewable energy generation device 10. The produced hydrogen and electrolyte are transferred to a gas-liquid separator 50 through an outlet of the stack, and in the gas-liquid separator 50, the hydrogen gas and the electrolyte produced at this time are separated.

The electrolyte separated through the gas-liquid separator 50 is returned to the electrolyte tank 40, and the produced hydrogen is transferred to a hydrogen purifier 60, and then the purity of hydrogen is increased to be purified into high-purity hydrogen.

On the other hand, in the case of the controller 20 in the present disclosure, the controller 20 is configured to drive the electrolysis stack module 30 including the electrolysis stacks 31, 32, 33, 34, and 35, no less than two. In particular, the controller 20 in the present disclosure is configured to drive each of the electrolysis stacks (31, 32, 33, 34, and 35).

In the case of the electrolysis stack module 30, the electrolysis stack module 30 is configured to include the electrolysis stacks 31, 32, 33, 34, and 35, wherein electrolysis stacks required for the electrolysis stack module 30 have to be operable, necessarily differentiated from each other, and no less than two. This is to divide and allocate the operable range for each stack and configure operation control according to the amount of power supply supplied from the renewable energy generation device 10 on the basis of the allocated operable range.

For example, when the electrolysis stack module 30 includes a single electrolysis stack with 5 MW capacity (hydrogen production capacity of 1000 Nm³/h) and has the operable range of 15%˜100%, then the amount of the hydrogen production of the electrolysis stack module becomes 150˜1000 Nm³/h. In this case, when the amount of the average power consumption 5.0 kWh/Nm³ is reflected, the amount of the power consumption is in the range of 750 kWh˜5000 kWh.

On the other hand, when the electrolysis stack module 30, which includes five electrolysis stacks, each with 1 MW capacity (hydrogen production capacity of 200 Nm³/h), instead of the single electrolysis stack, is used, and each of the electrolysis stacks has the operable range of 15%˜100%, then the amount of the hydrogen production of the electrolysis stack module becomes 30˜1000 Nm³/h. In this case, when the amount of the average power consumption of 5.0 kWh/Nm³ is reflected, the amount of the power consumption is in the range of 150 kWh˜5000 kWh.

Therefore, comparing the above two examples, when the electrolysis stack module 30 includes the single electrolysis stack with 5 MW capacity (hydrogen production capacity of 1000 Nm³/h), the minimum amount of power supply required to drive the stack is 750 kWh, whereas when the electrolysis stack module 30 including five electrolysis stacks, each with 1 MW capacity (hydrogen production capacity of 200 Nm³/h), is used, it is possible to drop the amount of the minimum power supply to a level of 150 kWh while maintaining the same hydrogen production capacity. This is because, in the former case, the amount of the minimum power required to drive the stack is 750 kWh, which corresponds to 15% of the minimum operable range of the 5 MW capacity, whereas in the latter case, the amount of the minimum power required to drive one electrolysis stack is decreased to 150 kWh, which corresponds to 15% of the minimum operable range of the 1 MW capacity.

Therefore, when the electrolysis stack module 30 and the controller 20 for control thereof are configured as described above, the operation range in which hydrogen production is possible may be substantially extended, so hydrogen production is possible even under conditions where the amount of power generation is extremely low. Therefore, there is an advantage in that stable and continuous hydrogen production is possible.

Therefore, the electrolysis system including the controller 20 according to the exemplary embodiment of the present disclosure includes a plurality of electrolysis stacks as in the latter case, and the controller 20 is configured to convert the power supply supplied from the renewable energy generation device 10, thereby allowing the amount of the power supply to be distributed and supplied to each of the electrolysis stacks according to operating conditions defined according to a preset amount of the supplied power. That is, according to the exemplary embodiment of the present disclosure, stack driving conditions corresponding to on/off of the electrolysis stacks corresponding to preset ranges of the amount of the power supply supplied are set dividedly, and distribution control of the amount of the power supply supplied from the renewable energy generation device 10 is carried out according to the stack driving conditions, whereby hydrogen productivity at a low load may be secured.

Specifically, the controller 20 may be configured to receive the power supply from the renewable energy generation device and to distribute the power to n (n≥2) electrolysis stacks, thereby controlling the supplied power. In addition, the controller 20 may be configured to determine whether or not to drive each of the electrolysis stacks according to the stack driving conditions, no less than two, determined on the basis of a preset minimum amount of operating power supply for each electrolysis stack. Here, the amount of the minimum operating power supply may be determined on the basis of a minimum operating coefficient α and a stack capacity A, and in this case, the minimum operating coefficient may be a unique value of the electrolysis stack set as a lower limit of the operable range of each of the electrolysis stacks. Accordingly, in the case of using the electrolysis stack having the same specification, the minimum operation coefficient α, the stack capacity A, and the minimum amount of operating power supply are all the same for all the stacks, respectively

The stack driving conditions may consist of n numbers of conditions according to n numbers of ranges of the amount of the power supply, and the controller 20 may determine whether or not each of the electrolysis stacks is to be driven according to the n numbers of the stack driving conditions determined on the basis of the minimum amount of operating power supply preset in advance for each of the electrolysis stacks. In addition, in the case of each of the stack driving conditions, an electrolysis stack to be driven for each of the stack driving conditions may be allocated. In addition, a lower limit value of each of the stack driving conditions may be set to integer multiples, no greater than n, of the amount of the minimum operating power supply, and the range of the amount of power supply for each of the stack operating conditions may be determined as the magnitude of the minimum amount of operating power supply.

For example, among the stack driving conditions, a first stack driving condition in which the electrolysis stack may be operated with the amount of the minimum supplied power is set to αA≤amount of supplied power<2αA, and the controller 20 may control to drive only the first electrolysis stack under the first stack driving condition. In addition, a second stack driving condition is set to 2αA≤amount of supplied power<3αA, and the controller 20 may control the second electrolysis stack to be driven together with the first electrolysis stack under the second stack driving condition. In the case of such an example, it is the case in which the first stack driving condition is allocated to allow the first electrolysis stack to be driven, and the second stack driving condition is allocated to allow the second electrolysis stack together with the first electrolysis stack to be driven.

As described above, in the case of the electrolysis system having n numbers of the electrolysis stacks, the system may be controlled according to the n numbers of stack driving conditions defined according to the n numbers of the ranges of the amount of power supply, and accordingly, the electrolysis stacks allocated to the stack driving conditions, respectively, may be controlled to be sequentially driven according to an increase of the amount of supplied power.

In this regard, FIG. 1 discloses an electrolysis system provided with an electrolysis stack module 30 including five electrolysis stacks. Hereinafter, an operation control method for such an electrolysis stack module will be described along with an example thereof.

When each of the five electrolysis stacks of FIG. 1 has an 1 MW capacity (hydrogen production capacity of 200 Nm³/h) and the amount of an average power consumption of 5.0 kWh/Nm³, and the operable range of the electrolysis stack is 15%˜100%, the stack operation conditions may be set as shown in Table 1 below.

TABLE 1

| | Range of amount of supplied | Allocated stack | |
|---|---|---|---|
| Driving condition | power | control | Remarks |
| First stack driving | 150 kWh ≤ Amount of supplied | First stack ON | Less than two folds of minimum |
| condition | power <300 kWh | | amount of operating power supply |
| Second stack driving | 300 kWh ≤ Amount of supplied | Second stack ON | Less than three folds of minimum |
| condition | power <450 kWh | | amount of operating power supply |
| Third stack driving | 450 kWh ≤ Amount of supplied | Third stack ON | Less than four folds of minimum |
| condition | power <600 kWh | | amount of operating power supply |
| Fourth stack driving | 600 kWh ≤ Amount of supplied | Fourth stack ON | Less than Five folds of minimum |
| condition | power <750 kWh | | amount of operating power supply |
| Fifth stack driving | 750 kWh ≤ Amount of supplied | Fifth stack ON | Remaining range |
| condition | power-<5000 kWh | | |

According to Table 1 above, in the first stack driving condition, power is supplied only to the first stack, so that only the first stack is driven, and in the second stack driving condition, the first and second stacks are driven. In addition, in the third stack driving condition, the first, second, and third stacks are driven, in the fourth stack driving condition, the first, second, third and fourth stacks are driven, and in the fifth stack driving condition, all electrolysis stacks are driven.

Distribution of the amount of supplied power in each of the stack driving conditions may be determined according to preset control logic, and the amount of supplied power distributed to each of the stacks may be controlled to be equal.

According to the example of Table 1, when the amount of power supply supplied from the renewable energy generation device is less than 300 kWh, hydrogen production of less than 60 Nm³/h is possible in the first stack, and when the amount of the supplied power is less than 450 kWh, hydrogen production of less than 45 Nm³/h is possible in each of the first and second stacks. In addition, when the amount of supplied power is less than 600 kWh, hydrogen production of less than 40 Nm³/h is possible in each of the first, second, and third stacks, and when the supplied power is less than 750 kW, hydrogen production of less than 37.5 Nm³/h is possible in each of the first, second, third, and fourth stacks. In the same manner, when the amount of supplied power is no less than 750 kWh and less than 5000 kWh, hydrogen production of no greater than 200 Nm³/h is possible in each of the stacks.

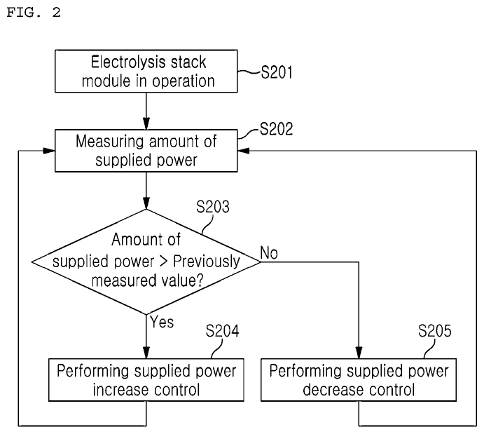

FIG. 2 is a flowchart explaining an example in which supplied power increase/decrease control is performed according to the amount of power supply of a renewable energy generation device during operation of the electrolysis stack module.

As shown in FIG. 2, when the electrolysis stack module is in operation in S201, the amount of power supply supplied from the renewable energy generation device is measured in real time in S202. For example, the amount of power supply supplied from the renewable energy generation device may be measured by a measuring device that may include a memory to store instructions or algorithms for performing the measurement and a processor to execute the stored instructions or algorithms to perform the measurement. The measuring device may be a part of the controller. Thereafter, the controller compares the amount W1 of supplied power measured at the previous measurement time with the amount W2 of supplied power currently measured, whereby confirming whether the amount of supplied power increases or decreases may be performed in S203.

At this time, when the currently measured amount W2 of supplied power is greater than the previously measured amount W1 of supplied power, this is the case where the supplied power is increased, so supplied power increase control is performed in S204.

On the contrary, when the currently measured amount W2 of supplied power is smaller than the previously measured amount W1 of supplied power, this is the case where the supplied power is decreased, so power supply decrease control is performed in S205.

Supplied power control refers not only to control the on/off of the electrolysis stack allocated to the stack driving conditions but also to be controlled by the controller in such a manner that the amount of power supply supplied to each of the electrolysis stacks is to be properly distributed according to the increased/decreased amount of supplied power.

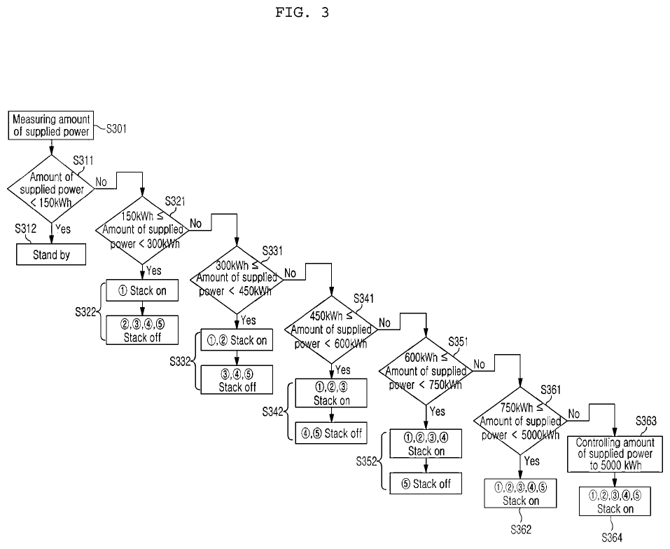

FIG. 3 is a flowchart illustrating an example of performing control according to an increase in the amount of supplied power in the operation control method for an electrolysis stack module powered by the renewable energy power generation device according to the embodiment of the present disclosure.

In particular, in FIG. 3, a case in which the amount of supplied power is sequentially increased from a point no greater than the stack operating range to a maximum operating range is described. The present example relates to an example in which five stack driving conditions are divided as shown in Table 1 and an electrolysis stack is allocated to each of the stack driving conditions.

As shown in FIG. 3, measuring the amount of supplied power is performed in real time in S301, and when the amount of supplied power is less than 150 kWh (minimum amount of operating power of the stack) in S311, this is the case where the electrolysis stack is impossible to be driven. Therefore, the electrolysis stack is not driven and stands by in S312.

On the other hand, when the amount of supplied power by the renewable energy generation device increases and thus the amount of supplied power is supplied in a range of 150 kWh≤amount of supplied power<300 kWh in S321, the controller controls the stacks in S322 such that the first stack is turned ON to be driven and the remaining stacks are kept in a state not to be driven.

When the amount of supplied power by the renewable energy generation device increases and thus the amount of supplied power is supplied in a range of 300 kWh≤amount of supplied power<450 kWh in S331, the controller controls the stacks in S332 such that the second stack is additionally turned ON to be driven and the remaining stacks that are the third, fourth, and fifth stacks are kept in a state not to be driven. In this case, the amount of supplied power to the first stack and the second stack may be controlled to be maintained with the same one another.

When the amount of supplied power increases again and thus the amount of supplied power is supplied in a range of 450 kWh≤amount of supplied power<600 kWh in S341, the controller controls the stacks in S342 such that the third stack is additionally turned ON to be driven and the remaining stacks that are the fourth and fifth stacks are kept in a state not to be driven. Even in this case, the amount of power supply supplied to the first to third stacks may be controlled to be maintained with the same one another.

In the same manner, when the amount of supplied power increases again and thus the amount of supplied power is supplied in a range of 600 kWh≤amount of supplied power<750 kWh in S351, the controller controls the stacks in S352 such that the fourth stack is additionally turned ON to be driven and the remaining stack of the fifth stack is kept in a state not to be driven.

Thereafter, when the amount of supplied power increases again and thus the amount of supplied power is supplied in a range of 750 kWh≤amount of supplied power<5000 kWh in S361, the controller controls the stacks in S362 such that the fifth stack is additionally turned ON to be driven, thereby all the electrolysis stacks are turned ON to be driven in S362.

When the amount of supplied power increases to no less than 5000 kWh, each of all the electrolysis stacks may be driven at the maximum capacity thereof. Therefore, the controller controls the amount of supplied power to 5000 kWh in S363, thereby allowing all the stacks to be driven in S364.

On the other hand, in a state where a plurality of electrolysis stacks are driven, when some of the electrolysis stacks need to be stopped due to a decrease in the amount of supplied power, the controller may control to stop driving the stacks in reverse order of the driving start order.

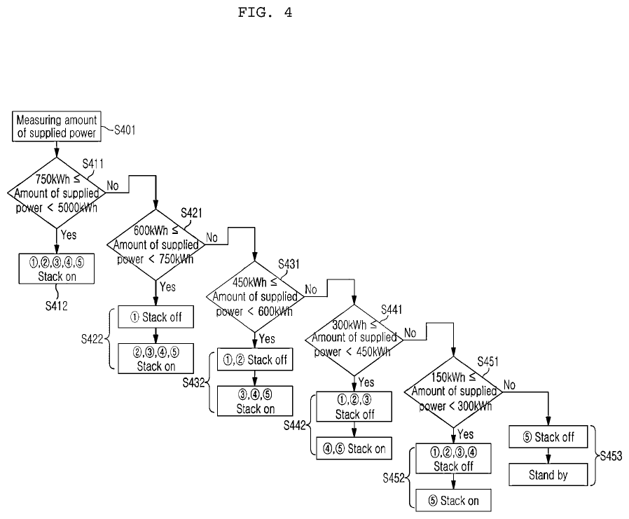

In this regard, FIG. 4 is a flowchart illustrating an example of performing control according to a decrease in the amount of supplied power in the operation control method for an electrolysis stack module powered by the renewable energy power generation device according to the embodiment of the present disclosure. In particular, in FIG. 4, the control due to a decrease in the amount of supplied power is described when the electrolysis stack module is operating in the range of 750 kWh≤amount of supplied power<5000 kWh.

As shown in FIG. 4, measuring the amount of supplied power is performed in real time in S401, whereby, when the range of 750 kWh≤amount of supplied power<5000 kWh is maintained in S411, all electrolysis stacks are controlled to be driven in S412.

On the other hand, when it is confirmed that, as the amount of supplied power from the renewable energy generation device decreases, the amount of supplied power is supplied in the range of 600 kWh≤amount of supplied power<750 kWh is supplied in S421, the controller controls the stacks in S422 such that the first stack is turned OFF not to be driven, and the remaining stacks that are the second, third, fourth, and fifth stacks are kept to be turned ON.

Thereafter, when it is confirmed that, as the amount of supplied power decreases again, the amount of supplied power is supplied in the range of 450 kWh≤amount of supplied power<600 kWh in S431, the controller controls the stacks in S432 such that the second stack is additionally turned OFF not to be driven, and the remaining stacks that are the third, fourth, and fifth stacks are kept to be turned ON.

When it is confirmed that, as the amount of supplied power decreases again, the amount of supplied power is supplied in the range of 300 kWh≤amount of supplied power<450 kWh in S441, the controller controls the stacks in S442 such that the third stack is turned OFF not to be driven, and the remaining stacks that are the fourth and fifth stacks are kept to be turned ON.

In addition, when, as the amount of supplied power decreases, the amount of supplied power is supplied in the range of 150 kWh≤amount of supplied power<300 kWh in S451, the controller controls the stacks in S452 such that the fourth stack is turned OFF not to be driven, and the remaining stack of the fifth stack only is kept to be turned ON.

Thereafter, when the amount of supplied power falls to less than 150 kWh (minimum amount of operating power of the stack), this is the case where the electrolysis stack is impossible to be driven. Therefore, the fifth stack is also turned OFF not to be driven, whereby all electrolysis stacks stand by in a state of being stopped in S453.

On the other hand, after some of the electrolysis stacks are stopped due to a decrease in the amount of supplied power, when some of the electrolysis stacks need to be additionally driven as the amount of supplied power increases again, the controller may drive the electrolysis stacks allocated to each of the stack driving conditions regardless of a driving order, thereby initializing the control conditions related to the driving order.

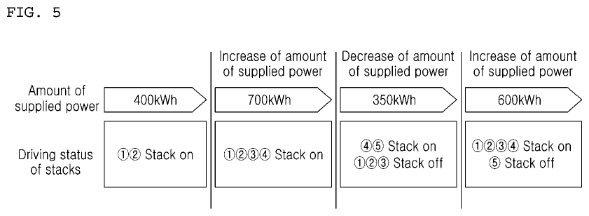

In this regard, FIG. 5 illustrates an example related to an on/off control of the electrolysis stacks according to the increase/decrease in the amount of supplied power.

As shown in FIG. 5, in a state where the amount of supplied power is supplied from the renewable energy generation device is 400 kWh, only the first and second stacks of the electrolysis stack module are controlled to be turned ON to be driven. Thereafter, when the amount of supplied power increases to 700 kWh, electrolysis stack module control is accomplished by the controller to allow the first, second, third, and fourth stacks allocated according to the fourth stack driving condition to be turned ON to be driven.

On the other hand, when, as the amount of supplied power that is supplied by the renewable energy generation device decreases, the amount of supplied power falls to 350 kWh, this corresponds to the second stack driving condition corresponding to the range of 300 kWh≤amount of supplied power<450 kWh. Therefore, only two electrolysis stacks are necessary to be kept to be turned ON.

At this time, as described in the example of FIG. 4 above, the stack to be turned off may be determined according to a stack driving order. In particular, control logic, configured to determine a stack to be turned off according to a change in the stack driving condition when several stacks need to be turned off at a time due to a sharp decrease in the amount of supplied power, may be stored in the controller in advance.

For example, when the amount of supplied power decreases from 700 kWh to 350 kWh, the first and second stacks, which are two stacks that were initially operated, may be preferentially turned off.

On the other hand, differently from the above, it may be set to change the stacks to be driven with the electrolysis stacks allocated to a lower priority, that is, with the electrolysis stacks that are activated at a relatively high amount of supplied power. In this case, the controller may control such that, as shown in FIG. 5, the fourth and fifth stacks corresponding to the lower priority of driving may be turned ON to be driven whereas the first, second, and third stacks are turned OFF not to be driven.

Thereafter, when the decreased amount of supplied power is recovered from 350 kWh to 600 kWh again and shows an increasing trend, as two stacks are required to be additionally turned ON to be driven according to the fourth stack driving condition, the driving order is initialized, whereby the first, second, third, and fourth stacks may be controlled to be turned on to be driven, and the fifth stack may be controlled to be turned off not to be driven.

Thereafter, since the driving order has been initialized, it may be controlled such that, when the amount of supplied power increases, the fifth stack is converted to be turned ON to be driven, and that when the amount of supplied power decreases, the first, second, and third stacks are sequentially turned OFF in order thereof, not to be driven.

Although shown and described with respect to specific embodiments of the present disclosure, it will be obvious to those of ordinary skill in the art that the present disclosure may be variously improved and changed without departing from the spirit of the present disclosure provided by the following claims.

What is claimed is:

1. A controller for an electrolysis stack module powered by a renewable energy power generation device, the controller being configured to control power supply by receiving the power supply from the renewable energy generator and distributing the power supply to n (n≥2) electrolysis stacks,
wherein, the controller is configured to determine whether or not to drive each electrolysis stack according to stack driving conditions, no less than two, determined on a basis of a minimum amount of operating power supply preset in advance for each of the electrolysis stacks, and
the stack driving conditions are ranges of an amount of the power supply in which on/off of the electrolysis stacks is predetermined, and the controller is configured to control driving of the electrolysis stacks according to the stack driving conditions corresponding to the amount of power supply supplied from the renewable energy generator.

2. The controller of claim 1, wherein the stack driving conditions consist of n numbers of conditions according to n numbers of ranges of the amount of the power supply,
the controller determines whether or not each of the electrolysis stacks is to be driven according to the n numbers of the stack driving conditions determined on the basis of the minimum amount of operating power supply preset in advance for each of the electrolysis stacks, and
an electrolysis stack to be driven is allocated for each of the stack driving conditions.

3. The controller of claim 2, wherein all of the n electrolysis stacks have the same stack capacity (A), and
the minimum amount of operating power supply is determined by a minimum operation coefficient (α) and the stack capacity (A).

4. The controller of claim 3, wherein a lower limit value of each of the stack driving conditions is set to a multiple of an integer, no greater than n, of the minimum amount of the operating power supply, and the range of the amount of the power supply for each of the stack operating conditions is determined as a magnitude of the minimum amount of the operating power supply.

5. The controller of claim 4, wherein, among the stack driving conditions, a first stack driving condition in which a first electrolysis stack is operable with a minimum amount of supplied power is set to
αA≤amount of supplied power<2αA, and
the controller controls to drive only the first electrolysis stack under the first stack driving condition, and the electrolysis stacks allocated to the stack driving conditions, respectively, are controlled to be sequentially driven in a driving start order according to an increase of the amount of the supplied power.

6. The controller of claim 5, wherein, in a state where a plurality of electrolysis stacks are driven, when some of the electrolysis stacks need to be stopped due to a decrease in the amount of the supplied power,
the controller controls to stop driving the electrolysis stacks in reverse order of the driving start order.

7. The controller of claim 6, wherein, after the some of the electrolysis stacks are stopped due to the decrease in the amount of the supplied power, when some of the electrolysis stacks need to be additionally driven as the amount of the supplied power increases again,
the controller allows the electrolysis stacks allocated to each of the stack driving conditions to be driven.

8. An operation control method for an electrolysis stack module powered by a renewable energy power generation device, the operation control method comprising controlling driving, by a controller, electrolysis stacks, the controlling driving includes receiving, by the controller, power from a renewable energy generator, distributing, by the controller, power supply to n (n≥2) electrolysis stacks,
determining, by the controller, whether or not to drive each electrolysis stack according to stack driving conditions, no less than two, on the a basis of a minimum amount of operating power supply preset in advance for each of the electrolysis stacks, and
driving, by the controller, the electrolysis stacks according to the stack driving conditions to which an amount of power supply supplied from the renewable energy generator corresponds, wherein the stack driving conditions are ranges of an amount of the power supply in which on/off of the electrolysis stacks is predetermined.

9. The operation control method of claim 8, further comprising, in a driving state of the electrolysis stack module:
measuring the current power supply;
checking whether the amount of the power supply is increased or decreased by comparing, by the controller, a previously measured amount of power supply (W1) and the currently measured amount of power supply (W2); and
performing, by the controller, power supply control according to a result of the checking whether the amount of the power supply is increased or decreased,
wherein the performing of the power supply control includes controlling, by the controller, the amount of the power supply supplied to the electrolysis stacks allocated to the stack driving conditions according to the increased or decreased amount of the power supply.

10. The operation control method of claim 9, wherein the stack driving conditions consist of n numbers of conditions according to n numbers of ranges of the amount of the power supply, and
the operation control method further comprising:
determining, by the controller, whether or not each of the electrolysis stacks is to be driven according to the n numbers of the stack driving conditions determined on the basis of the minimum amount of operating power supply preset in advance for each of the electrolysis stacks, and
an electrolysis stack to be driven is allocated for each of the stack driving conditions.

11. The operation control method of claim 10, wherein all of the n electrolysis stacks have the same stack capacity (A), and
the minimum amount of operating power supply is determined by a minimum operation coefficient (α) and the stack capacity (A).

12. The operation control method of claim 11, wherein a lower limit value of each of the stack driving conditions is set to a multiple of an integer, no greater than n, of the minimum amount of the operating power supply, and the range of the amount of power supply for each of the stack operating conditions is determined as a magnitude of the minimum amount of operating power supply.

13. The operation control method of claim 12, wherein, among the stack driving conditions, a first stack driving condition in which a first electrolysis stack is operable with a minimum amount of supplied power is set to
αA≤amount of supplied power<2αA, and
the controlling driving of the electrolysis stacks further includes driving, by the controller, only the first electrolysis stack under the first stack driving condition, and sequentially driving, by the controller, the electrolysis stacks allocated to the stack driving conditions, respectively, in a driving start order according to an increase of the amount of the supplied power.

14. The operation control method of claim 13, wherein in a state where a plurality of electrolysis stacks are driven, when it is determined that some of the electrolysis stacks need to be stopped due to a decrease in the amount of the supplied power, through the checking whether the amount of the power supply is increased or decreased,
the performing of the power supply control further includes controlling stopping driving, by the controller, the electrolysis stacks in reverse order of the driving start order.

15. The operation control method of claim 14, wherein when it is confirmed that, after the power supply control is performed as the amount of power supply decreases, and after some of the electrolysis stacks are stopped to be driven due to the decrease in the amount of the supplied power, the amount of the supplied power increases again through the checking whether the amount of power is increased or decreased,
the operation control method further comprising:
checking, by the controller, whether some of the electrolysis stacks need to be driven or not additionally as the amount of supplied power increases again, and
allowing, by the controller, the electrolysis stacks allocated to the respective stack driving conditions to be driven when it is confirmed that some of the electrolysis stacks need to be driven additionally.
